(19) United States
(12) Patent Application Publication
(10) Pub. No.: US 2010/0017440 A1
(43) Pub. Date: Jan. 21, 2010

(54) DIGITAL IMAGE FILE DISPLAY SYSTEM AND METHOD

(75) Inventor: JIAN-FENG GUO, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) CO.,LTD., Shenzhen City (CN); HON HAI PRECISION INDUSTRY CO., LTD., Tu-Cheng (TW)

(21) Appl. No.: 12/333,647

(22) Filed: Dec. 12, 2008

(30) Foreign Application Priority Data
Jul. 18, 2008 (CN) 200810302808.X

(51) Int. Cl. G06F 17/30

(52) U.S. Cl. 707/104.1; 707/E17.01; 707/E17.019

(57) ABSTRACT

A digital image file display system includes a storage device and a DPF. The storage device includes a marking module, a first sending module, and a first receiving module. The DPF includes a display module, a second sending module, and a second receiving module. The marking module assigns digital image files not previously displayed by the DPF to a list. The first sending module sends notification about the list to the DPF. The second receiving module receives the notification, and the second sending module sends a request to the storage device to display the digital image files of the list. The first receiving module receives the request, and the first sending module sends the list to the DPF. The second receiving module receives the list, and the display module displays the digital image file of the list or properties thereof. A digital image file display method is also provided.

### BACKGROUND

1. Technical Field

The present disclosure relates to a display system and a method for a digital image file.

2. Description of the Related Art

A typical digital photo frame (DPF) communicates with a storage device, such as a computer system, a server, or other device capable of storing digital image files. The typical DPF can display the digital image files of the storage device. However, the typical DPF usually displays all the digital image files, even if the digital image files have been previously displayed.

Therefore, there is room for improvement within the art.

### BRIEF DESCRIPTION OF THE DRAWINGS

FIG. 1 is a block diagram of an embodiment of a digital image file display system.

FIG. 2 is a flow chart illustrating an embodiment of a method for displaying digital image files by using the system of FIG. 1.

### DETAILED DESCRIPTION OF THE EMBODIMENTS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

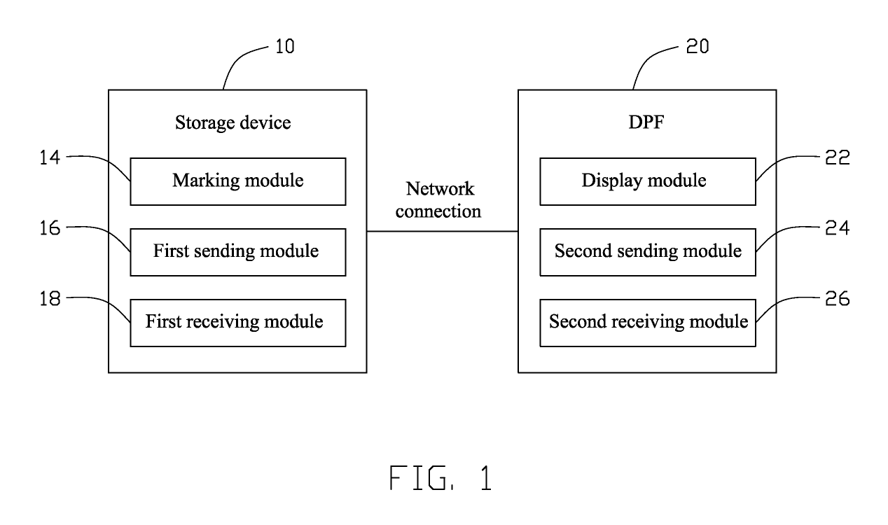

Referring to FIG. 1, an embodiment of a digital image file display system includes a storage device 10 with a plurality of digital image files stored therein, and a digital photo frame (PDF) 20 communicating with the storage device 10 via a network connection.

The storage device 10 may be a computer, a server, or other device, and includes a marking module 14, a first sending module 16, and a first receiving module 18. The marking module 14 assigns digital photo images that have been displayed to a first list, and those that have not been displayed to a second list. The first sending module 16 sends information, such as the first and second lists, to the DPF 20. The first receiving module 18 receives information, such as requests for displaying the digital image files, from the DPF 20.

The DPF 20 includes a display module 22, a second sending module 24, and a second receiving module 26. The display module 22 displays the digital image files of the storage device 10. The second sending module 24 sends information, such as requests for displaying the digital image files, to the storage device 10. The receiving module 26 receives the information, such as the first and second lists of the digital image photos, sent from the storage device 10.

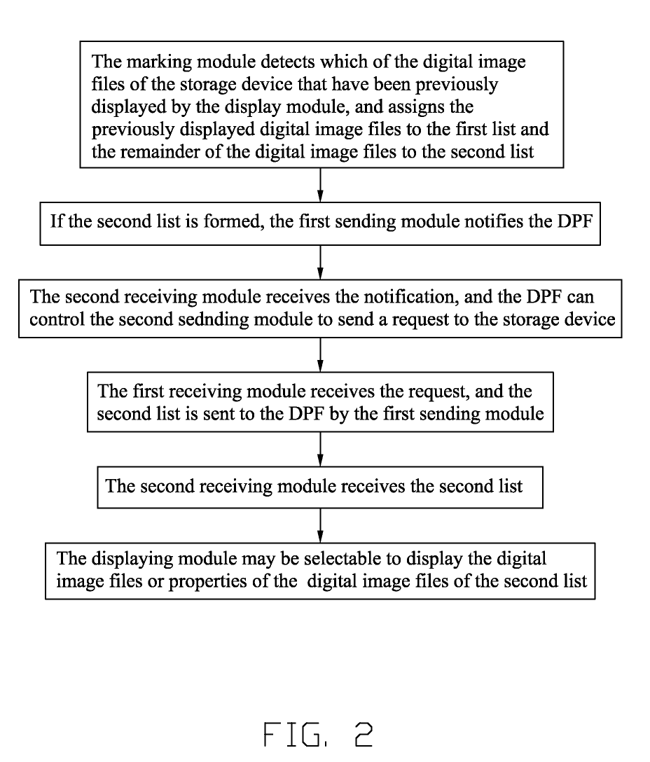

Referring also to FIG. 2, an embodiment of a method for displaying the digital image files using the digital image file display system is shown. Depending on the embodiment, certain of the steps described below may be removed, others may be added, and the sequence of steps may be altered.

The storage device 10 and the DPF 20 are switched on. The DPF 20 communicates with the storage device 10 via the network connection, and can access the storage device 10.

The marking module 14 detects which of the digital image files, if any, of the storage device 10 that have been previously displayed by the display module 22 of the DPF 20, and assigns the previously displayed digital image files to the first list and the remainder of the files to the second list. If the second list is formed, the first sending module 16 notifies the DPF 20. The second receiving module 26 of the DPF 20 receives the notification. Then, the DPF 20 can control the second sending module 24 to send a request to the storage device 10 to send the second list. The first receiving module 18 receives the request, and the second list is sent to the DPF 20 by the first sending module 16. The second receiving module 26 receives the second list.

The display module 22 may be selectable to display the digital image files or properties of the digital image files of the second list. If a display of the digital image files of the second list is selected, the display module 22 displays the digital image files of the second list. Either during or after the digital image files are displayed by the display module 22, the marking module 14 assigns the digital image files to the first list and purges the digital image files from the second list. If a display of the properties of the digital image files of the second list is selected, the display module 22 displays the properties, and contents of the first and second lists remain unchanged.

In the illustrated embodiment, the properties of the digital image files may include titles, setting times, remarks, bytes, caption, or other information of the digital image files.

It is to be understood, however, that even though numerous characteristics and advantages have been set forth in the foregoing description of embodiments, together with details of the structures and functions of the embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A digital image file display system, comprising:
a storage device having a plurality of digital image files stored therein, and comprising a marking module, a first sending module, and a first receiving module; and
a digital photo frame (DPF) communicating with the storage device, and comprising a display module, a second sending module, and a second receiving module;
wherein the marking module assigns the digital image files not previously displayed by the DPF to a list; the first sending module sends a notification about the list to the DPF; the second receiving module receives the notification, and the second sending module sends a request to the storage device to display the digital image files of the list; the first receiving module receives the request, and the first sending module sends the list to the DPF; the second receiving module receives the list, and the display module displays the digital image file or properties of the digital image files of the list.

2. The digital image file display system of claim 1, wherein the marking module also detects the digital image files not previously displayed by the DPF in the storage device.

3. The digital image file display system of claim 1, wherein the marking module also removes the digital image files displayed by the display module of the DPF from the list after the digital image files of the list are displayed.

4. The digital image file display system of claim 1, wherein the list remains unchanged after the properties of the digital image files of the list are displayed by the display module of the DPF.

5. The digital image file display system of claim 1, wherein the properties of each of the digital image files comprises at least one of title, bytes, setting time, and caption of each of the digital image files.

6. The digital image file display system of claim 1, wherein the DPF communicates with the storage device via a network connection.

7. A digital image file display method, comprising:
assigning digital image files of a storage device not displayed by a digital photo frame (DPF) to a list;
sending notification about the list from the storage device to the DPF;
receiving the notification by the DPF;
sending a request for displaying the digital image files of the list from the DPF to the storage device;
receiving the request and sending the list to the DPF by the storage device; and
displaying the digital image files or properties of the digital image files of the list by the DPF.

8. The digital image file display method of claim 7, further comprising removing the digital image files from the list.

9. The digital image file display method of claim 7, wherein the list remains unchanged after the properties of the digital image files of the list are displayed by the DPF.

10. The digital image file display method of claim 7, further comprising detecting the digital image files not displayed by the DPF in the storage device before assigning the digital image files not displayed by the DPF to the list.
